(19) United States
(12) Patent Application Publication
(10) Pub. No.: US 2024/0001649 A1
(43) Pub. Date: Jan. 4, 2024

(54) METHOD FOR MANUFACTURING SOLAR-CONTROL LAMINATED GLASS

(71) Applicant: SAINT-GOBAIN GLASS FRANCE, COURBEVOIE (FR)

(72) Inventors: Koucun ZHANG, SHANGHAI (CN); Bernard NGHIEM, LACROIX SAINT OUEN (FR); Guillaume GAUTHIER, DABROWA GORNICZA (PL)

(21) Appl. No.: 18/251,783

(22) PCT Filed: Nov. 10, 2021
(86) PCT No.: PCT/CN2021/129684

§ 371 Date: May 4, 2023

(30) Foreign Application Priority Data
Nov. 12, 2020 (CN) 202011260023.8

(51) Int. Cl. B32B 17/10

(52) U.S. Cl. CPC B32B 17/1088; B32B 17/10889; B32B 17/10935; B32B 17/10871; B32B 17/10834; B32B 17/10633; B32B 17/10211; B32B 17/10036; B32B 2313/04; B32B 2255/20; B32B 2307/204; B32B 2307/416; B32B 2307/71

(57) ABSTRACT

A method for manufacturing a solar-control laminated glass including an outer and inner glass plate and an interlayer sandwiched between the outer and the inner glass plate, the method including providing the outer glass plate and the inner glass plate; forming a solar-control coating on a surface of at least one of the outer glass plate and the inner glass plate; heating the outer glass plate and the inner glass plate; hot-bending the heated outer glass plate and the heated inner glass plate respectively to obtain a glass-plate shape suitable for a subsequent pairing; pairing the hot-bent outer glass plate and the hot-bent inner glass plate, and inserting the interlayer between the outer glass plate and the inner glass plate to form an assembly; and heating and pressurizing the assembly to laminate the outer glass plate, the interlayer, and the inner glass plate together to form a laminated glass.

### RELATED FIELD

The present disclosure relates to a method for manufacturing a solar-control laminated glass, and a solar-control laminated glass manufactured according to the method.

### BACKGROUND

A laminated glass, also known as “a sandwich glass”, is formed by gluing two glass plates together via a strongly adhesive interlayer. When the glass suffers from an impact due to an external force, the interlayer is capable of absorbing most of impact energy to prevent an impacting object from penetrating the glass, and the interlayer is further capable of gluing glass fragments to avoid secondary injury to personnel. Therefore, the laminated glass is widely used in the field of construction and vehicle.

In order to ensure that the glass plates for forming the laminated glass have a same or similar curvature, a paired hot-bending process is generally used, and comprises pairing two glass plates for forming the laminated glass at an entrance of a hot-bending furnace, then placing them on a same bending mold, and performing a simultaneous hot-bending to obtain glass plates with a consistent curvature.

According to demands of current market, people not only have higher requirements to the diversity of curvature design of the glass, but also expect that the glass is capable of blocking most of solar energy outside vehicle. Taking a vehicle glass as an example, the current design of the vehicle glass tends to be unconventional, and heat insulation is also highly expected. On one hand, it is required that the curvatures of the two glass plates for forming the laminated glass remain consistent after hot-bending, and on the other hand, at least one of the two glass plates contains a solar-control coating, or the two glass plates contain solar-control coatings with different functions, for example, an infrared reflective coating or a low-emissivity coating.

### SUMMARY

However, an inventor of the present disclosure realized that, when only one of the two glass plates is provided with a solar-control coating, or the two glass plates are provided with solar-control coatings with different properties, hot-bending rates of the two glass plates under a same hot-bending parameter are different. Therefore, a same curvature for the two glass plates is unobtainable according to the existing paired hot-bending process, thus an acceptable laminated glass cannot be formed.

In view of this, embodiments of the present disclosure provide a method for manufacturing a solar-control laminated glass that solves or at least partially solves the above-mentioned problems and other potential problems in the method for manufacturing a solar-control laminated glass in the prior art.

Specifically, the present disclosure provides a method for manufacturing a solar-control laminated glass comprising an outer glass plate 10, an inner glass plate 20 and an interlayer 30 sandwiched between the outer glass plate and the inner glass plate. The method comprises following steps:
providing the outer glass plate 10 and the inner glass plate 20;
forming a solar-control coating on a surface of at least one of the outer glass plate 10 and the inner glass plate 20;
heating the outer glass plate 10 and the inner glass plate 20;
hot-bending the heated outer glass plate 10 and the heated inner glass plate 20 respectively to obtain a glass-plate shape suitable for a subsequent pairing, wherein the glass plates are hot-bent generally against a bending mold;
pairing the hot-bent outer glass plate 10 and the hot-bent inner glass plate 20, and inserting the interlayer 30 between the outer glass plate and the inner glass plate to form an assembly; and
heating and pressurizing the assembly to laminate the outer glass plate 10, the interlayer 30, and the inner glass plate 20 together to form a laminated glass.

According to the method of the present disclosure, the two glass plates for forming the laminated glass are subjected to a hot-bending treatment in batches and in turn by those skilled in the art, which is different from the existing paired hot-bending process. Specifically, in the existing paired hot-bending process, the two glass plates are simultaneously subjected to a hot-bending treatment under a same hot-bending parameter; while according to the method of the present disclosure, the two glass plates are subjected to a hot-bending treatment under different hot-bending parameters in batches. That is to say, those skilled in the art may arrange corresponding hot-bending parameters respectively according to whether the two glass plates for forming the laminated glass contain a solar-control coating and to the property of the solar-control coating, so as to ensure that the two hot-bent glass plates have a same curvature, thereby satisfying a subsequent curvature matching between the two glass plates. Therefore, according to the method of the present disclosure, the diversity of design of the laminated glass may be satisfied, and the additional value of the glass may be further increased.

In addition, the solar-control coating is relatively fragile in general, and may be damaged due to a scratch during contact with the metal bending mold. According to the present disclosure, by providing a high-temperature resistant polymer mixture on the surface of the bending mold, a gentle contact between the bending mold and the solar-control coating may be achieved, thereby protecting the solar-control coating from damage.

It should be understood that the summary of the present disclosure is neither intended to determine the crucial or basic features of the present disclosure, nor to limit the scope of the present disclosure. Other features of the present disclosure will be more readily understood from the following description.

### BRIEF DESCRIPTION OF THE DRAWINGS

The present disclosure will be described in more detail hereinafter with reference to the accompanying drawings to facilitate a better understanding of the purpose, features, and advantages of the present disclosure.

FIG. 1 is a schematic flow chart of a method for manufacturing a solar-control laminated glass according to an embodiment of the present disclosure;

FIGS. 2a to 2c are schematic cross-sectional views of a solar-control laminated glass manufactured according to the method shown in FIG. 1;

FIG. 3 is a schematic flow chart of the method for manufacturing a solar-control laminated glass according to another embodiment of the present disclosure;

FIG. 4 is a schematic cross-sectional view of a solar-control laminated glass manufactured according to the method shown in FIG. 3; and

FIG. 5 is a schematic top view of a solar-control laminated glass manufactured according to an embodiment of the present disclosure.

Throughout the drawings, a same or similar reference numeral is used to denote same or similar elements.

### DETAILED DESCRIPTION

As mentioned above, in case that the paired glass plates have different hot-bending properties, the existing paired hot-bending technology is not suitable for the application of manufacturing a laminated glass with such glass plates. Taking a solar-control laminated glass as an example, when only one of the two glass plates for forming the laminated glass contains a solar-control coating, while the other one does not contain a solar-control coating, or when the two glass plates contain solar-control coatings with different emissivities, the hot-bending rates of the two glass plates are different, and it is difficult to achieve matched curvatures with the existing paired hot-bending technology.

In order to solve the above problem, the present disclosure provides a method for manufacturing a solar-control laminated glass. According to the method of the present disclosure, those skilled in the art may arrange corresponding hot-bending parameters respectively according to whether the two glass plates for forming the laminated glass contain a solar-control coating and to the property of the solar-control coating, so as to ensure that the two hot-bent glass plates have a same curvature, thereby satisfying a subsequent curvature matching between the two glass plates.

The present disclosure will be further described hereinafter with reference to the following exemplary embodiments to enable those skilled in the art to fully understand the present disclosure. It should be understood that these embodiments are discussed only to enable those skilled in the art to better understand and thereby achieving the subject matter described in the present disclosure, rather than to impose any limit to the protection scope, applicability, or examples set forth in the claims. Without departing from the protection scope of the present disclosure, various features may be omitted, replaced, or added in various embodiments as needed. In addition, features described in some embodiments may also be combined in other embodiments.

In the present disclosure, the term “comprising” and its various variants may be understood as open-ended terms, which mean “comprising but not limited to”. The term “one embodiment” may be understood as “at least one embodiment”. The term “another embodiment” may be understood as “at least one another embodiment.” Other terms that may appear but are not mentioned here, unless explicitly stated, should not be construed or defined in a manner that is contrary to the concept on which the embodiments of the present disclosure are based.

In order to make the above objects, features and advantages of the present disclosure clear and easy to understand, embodiments of the present disclosure are described in detail below with reference to the drawings.

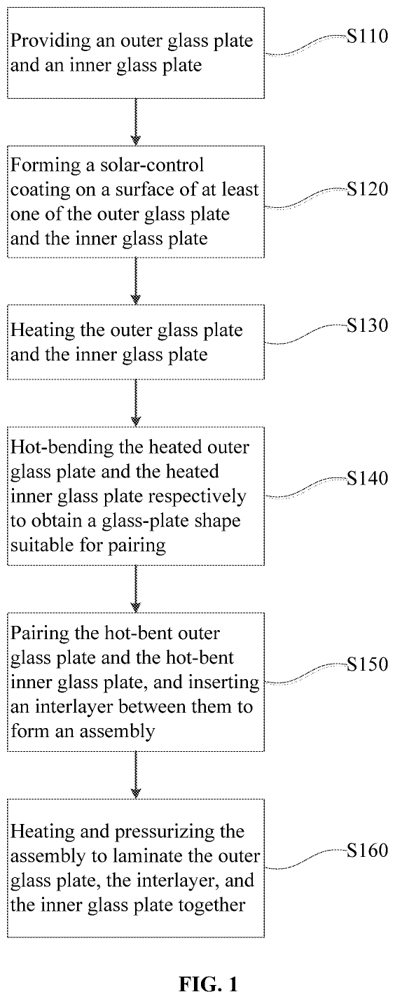

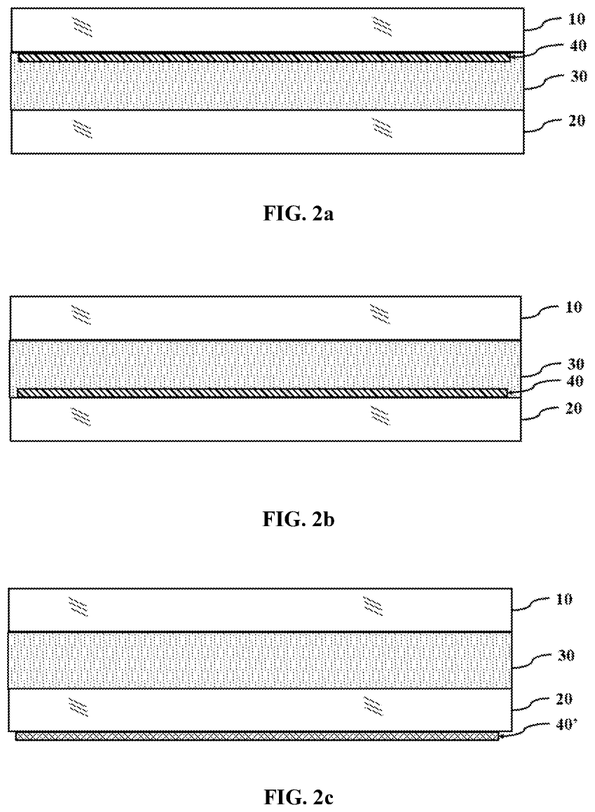

First, an embodiment of the method for manufacturing a solar-control laminated glass according to the present disclosure is described below with reference to FIG. 1, and FIG. 2a to FIG. 2c. It should be understood that, although several specific steps are shown herein, those skilled in the art may also add one or more steps thereto, delete one or more steps therefrom, or replace one or more steps with other steps, etc. without departing from the principle and spirit of the present disclosure.

In this embodiment, a vehicle glass is taken as an example. However, it should be noted that the present disclosure is not limited to the field of vehicle, and the solar-control laminated glass may also be, for example, an architectural glass.

The solar-control laminated glass comprises an outer glass plate 10, an inner glass plate 20 and an interlayer 30 sandwiched between the two glass plates. In an embodiment, the outer glass plate 10 is arranged to face the external environment (for example, outdoors or the exterior the vehicle), and the inner glass plate 20 is arranged to face the internal environment (for example, indoors or the interior the vehicle). Further, the outer glass plate comprises a first surface (face I) facing the external environment and a second surface (face II) facing the interlayer, the inner glass plate comprises a fourth surface (face IV) facing the internal environment (for example, indoors or the interior the vehicle) and a third surface (face III) facing the interlayer, and the second surface (face II) of the outer glass plate and the third surface (face III) of the inner glass plate are opposite to each other.

The interlayer 30 is formed by one or more thermoplastic films. The thermoplastic film preferably contains polyvinyl butyral (PVB), ethylene-vinyl acetate (EVA), polyurethane (PU) and/or a mixture and/or a copolymer thereof, and more preferably polyvinyl butyral. The film is preferably formed based on the above material, but may also contain other ingredients, such as a plasticizer, a colorant, an IR or UV absorber, the content of which is preferably less than 50%.

Specifically, the method for manufacturing solar-control laminated glass comprises the following steps:
with reference to FIG. 1, performing a step S110: providing the outer glass plate 10 and the inner glass plate 20; and a step S120: forming a solar-control coating on a surface of at least one of the outer glass plate 10 and the inner glass plate 20.

In this disclosure, a “solar-control coating” refers to a coating capable of controlling proportion of solar radiation passing through the glass. In general, the control is to reduce the proportion of solar radiation passing through the glass. When the solar radiation reaches the solar-control laminated glass, the solar-control laminated glass is capable of blocking a part of the radiation, such that the radiation degree of the side of the laminated glass opposite to the solar radiation source becomes relatively low.

It is known in the art that, a part of the solar energy that reaches the surface of the glass leaves through reflection from the glass, a part of the solar energy reaches the interior of the vehicle through transmission, and the other part of the solar energy is absorbed by the glass itself. The absorbed part of the energy will be secondarily radiated in all directions, and a part of it will enter the vehicle.

In the present disclosure, the solar-control coating comprises an infrared reflective coating and a low-emissivity coating. By providing the infrared reflective coating, the property of the glass to reflect solar energy in the infrared band can be improved. The low-emissivity coating is a poor radiator for the long-wavelength infrared band, and its emissivity value is generally 0.05-0.45 (measured according to EN12898). By providing the low-emissivity coating on the glass surface (for example the above-mentioned fourth surface) closest to the internal environment (indoors or the interior the vehicle), the secondary radiation generated by the heat absorbed by the glass can be reduced, such that the total energy entering the internal environment is reduced. In a hot summer, the low-emissivity coating is capable of significantly reducing heat energy entering the vehicle through the secondary radiation; while in a cold winter, the low-emissivity coating is capable of reflecting heat radiation generated by a human body back into the vehicle, thereby suppressing heat loss in the vehicle. Based on the low-emissivity coating, the secondary radiation from the glass plate to the interior of the vehicle in summer as well as the radiation from the glass plate to the external environment in winter can be effectively reduced.

The above examples of the solar-control coating are only for illustration, and are not intended to limit the protection scope of the present disclosure. Those skilled in the art may select an appropriate solar-control coating according to actual needs without departing from the protection scope of the present disclosure. For example, in some alternative embodiments, the solar-control coating may be a coating capable of reflecting or absorbing solar radiation in a wavelength band other than the visible spectrum, such as an infrared reflective coating or an infrared absorbing coating.

Generally, the solar-control coating has a laminated structure comprising at least one metal layer and at least one dielectric layer. Specifically, the infrared reflective coating comprises at least one transparent metal layer adjacent to the dielectric layer. The metal layer preferably comprises silver, because the silver has a relatively neutral color effect and selectively reflects infrared ray. In a preferred embodiment, the infrared reflective coating has two, three, four or more silver functional layers. As the number of the silver functional layers increases, the reflection property thereof for infrared ray becomes higher, and the number is not specifically defined in the present disclosure.

The dielectric layer is preferably formed based on a dielectric oxide or nitride, such as ZnO, SnZnO, AlN, SiO₂, TiO₂, or Si₃N₄. The dielectric layer mainly improves the optical properties of the coated glass plate through its refractive index and protects the metal layer from oxidation.

It is known to those skilled in the art that the infrared reflective coating may be formed on a surface of glass plate by, for example, a magnetron sputtering method. An appropriate infrared reflective coating has been described in, for example, WO2013/104439A1 and DE19927683C1, which are incorporated herein by reference in their entirety.

Similarly, the low-emissivity coating generally comprises a stack of multiple layers, comprising at least one metal layer and at least one dielectric layer adjacent to the dielectric layer. As the number of layers increases, the low emissivity property of the coating may be further enhanced. The metal layer is generally formed by a conductive metal compound. The conductive metal compound comprises indium tin oxide, tin oxide doped with antimony or fluorine, and/or zinc oxide doped with gallium and/or aluminum (ZnO:Ga or ZnO:Al), wherein indium tin oxide is preferred. The conductive metal compound may further contain another conductive oxide, such as indium-tin mixed oxide (IZO), titanium oxide doped with niobium, cadmium stannate, and/or zinc stannate. The dielectric layer contains dielectric oxide or nitride, such as ZnO, SnZnO, AlN, SiO₂, TiO₂, or Si₃N₄.

Similarly, the low-emissivity coating may be formed on a glass surface by an offline process, such as a sputtered coating deposited by magnetron sputtering under a vacuum condition, which is generally softer than a coating formed by an online process such as chemical vapor deposition (CVD). An appropriate low-emissivity coating has been described in, for example, WO2013/1316672A1, which is incorporated herein by reference in its entirety.

As shown in FIGS. 2a and 2b, in some embodiments, an infrared reflective coating is provided on at least one surface of the outer glass plate or the inner glass plate, and no coating is provided on the other glass plate; preferably, the infrared reflective coating 40 is provided on the surface of the outer glass plate or the inner glass plate close to the interlayer (for example, the above-mentioned second surface or third surface); more preferably, the infrared reflective coating 40 is provided on the above-mentioned second surface. For example, in a specific embodiment, the infrared reflective coating 40 is provided only on the second surface, and no coating is provided on the other surfaces of the laminated glass.

As shown in FIG. 2c, in other embodiments, a low-emissivity coating 40′ is provided on the surface of the inner glass plate facing the internal environment (for example, the above-mentioned fourth surface), while no coating is provided on the other glass plate.

Further referring to FIG. 1, a step S130 and a step S140 are performed: heating the outer glass plate 10 and the inner glass plate 20, and hot-bending the heated outer glass plate 10 and the heated inner glass plate 20 respectively against a bending mold to obtain a glass-plate shape suitable for a subsequent pairing.

In some embodiments, in the heating step, the two glass plates are delivered into a heating furnace in different batches and in turn and are heated to a temperature close to a softening point of the glass plates; then, the glass plates are further heated to over 600° C., and then the heated glass plates are placed on the bending mold, such as a forming ring, so as to be bent and formed by gravity or by a roller table.

In some embodiments, the outer glass plate and the inner glass plate are hot-bent under different hot-bending parameters, wherein the heating parameter comprises temperature, wind speed, sinking time, and the like. Those skilled in the art may arrange corresponding hot-bending parameters respectively according to whether the two glass plates for forming the laminated glass contain a solar-control coating and to the property of the solar-control coating, so as to ensure that the two hot-bent glass plates have a same curvature, thereby satisfying a subsequent curvature matching between the two glass plates. In an actual operation, those skilled in the art may arrange corresponding hot-bending parameters according to past experience, or arrange corresponding hot-bending parameters according to a machine learning model, which is not specifically defined in the present disclosure.

In addition, the solar-control coating is generally relatively fragile, and may be damaged due to a scratch during contact with the metal bending mold. According to the present disclosure, by providing a high-temperature resistant polymer mixture on the surface of the bending mold in contact with glass plate, a flexible contact between the surface of the bending mold and the solar-control coating may be achieved, thereby protecting the solar-control coating from damage.

In the present disclosure, a “high-temperature resistant polymer mixture” refers to a mixture of a high-temperature resistant polymer and metal yarn. In some embodiments, the high-temperature resistant polymer is selected from PBO fiber or Kevlar fiber, wherein PBO fiber is the abbreviation of poly-p-phenylene benzobisoxazole fiber, and Kevlar fiber is the brand name of poly-p-phenylene terephthalamide fiber. It should be understood that the above examples of the high-temperature resistant polymer mixture are only illustrative and are not intended to limit the protection scope of the present disclosure. Those skilled in the art may select an appropriate material according to actual needs without departing from the protection scope of the present disclosure.

Further referring to FIG. 1, a step S150 is performed: pairing the hot-bent outer glass plate 10 and the hot-bent inner glass plate 20, and inserting the interlayer 30 between them to form an assembly. Specifically, this step can be implemented in a cleaning chamber, wherein a PVB (polyvinyl butyral) layer is inserted between two hot-bent glass plates.

Further referring to FIG. 1, a step S160 is performed: heating and pressurizing the assembly to laminate the outer glass plate 10, the interlayer 30, and the inner glass plate 20 together. Specifically, in the heating and pressurizing treatment, an autoclave is generally required to perform a thorough vacuuming to ensure a complete adhesion between the two glass plates and the interlayer.

It should be understood that, although several specific steps are shown herein, those skilled in the art may also add one or more steps thereto, delete one or more steps therefrom, or replace one or more steps with other steps, etc. without departing from the principle and spirit of the present disclosure. For example, before the step of forming the coating on the surface of glass plate, the method generally further comprises steps of cutting and cleaning, etc., and after the step of hot-bending, the method generally further comprises steps of cooling and cleaning etc.

Correspondingly, the present disclosure provides a solar-control laminated glass, the specific structure of which is described below with reference to FIGS. 2a to 2c. FIG. 2a shows an embodiment of a solar-control laminated glass manufactured according to the flow chart shown in FIG. 1, and comprising an outer glass plate 10, an inner glass plate 20, and an interlayer 30 sandwiched between the two glass plates, wherein a solar-control coating 40 is provided on a surface of the outer glass plate 10 facing the interlayer 30. FIG. 2b shows another embodiment of the solar-control laminated glass, which is different from FIG. 2a in that the solar-control coating 40 is provided on a surface of the inner glass plate 20 facing the interlayer 30. In the solar-control laminated glasses shown in FIGS. 2a and 2b, the solar-control coating 40 is an infrared reflective coating. As mentioned above, the infrared reflective coating is capable of reflecting solar energy of the infrared band, thereby reducing heat that reaches the internal environment through the glass.

FIG. 2c shows another embodiment of the solar-control laminated glass manufactured according to the flow chart shown in FIG. 1, and comprising the outer glass plate 10, the inner glass plate 20, and the interlayer 30 sandwiched between the two, wherein a solar-control coating 40′ is provided on the surface of the inner glass plate 20 away from the interlayer (that is, the surface close to the internal environment), and the solar-control coating 40′ is a low-emissivity coating. As mentioned above, the low-emissivity coating is capable of reducing the secondary radiation to the internal environment after the glass absorbs heat, thereby reducing the energy of the solar radiation reaching the internal environment.

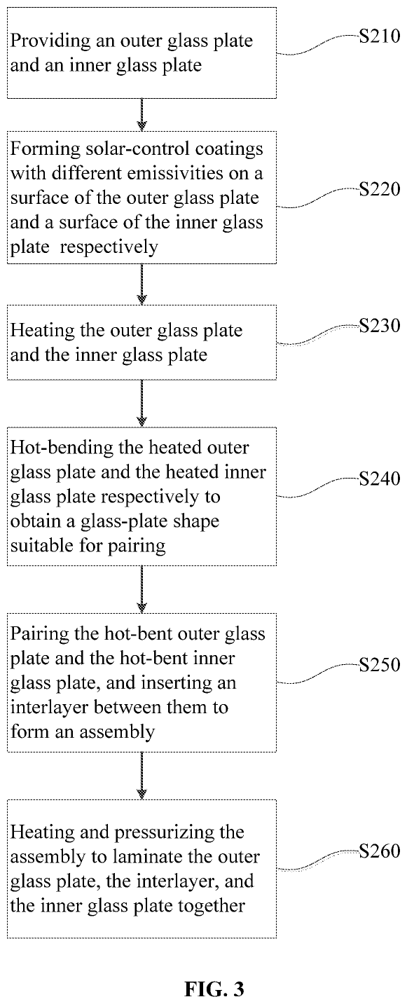

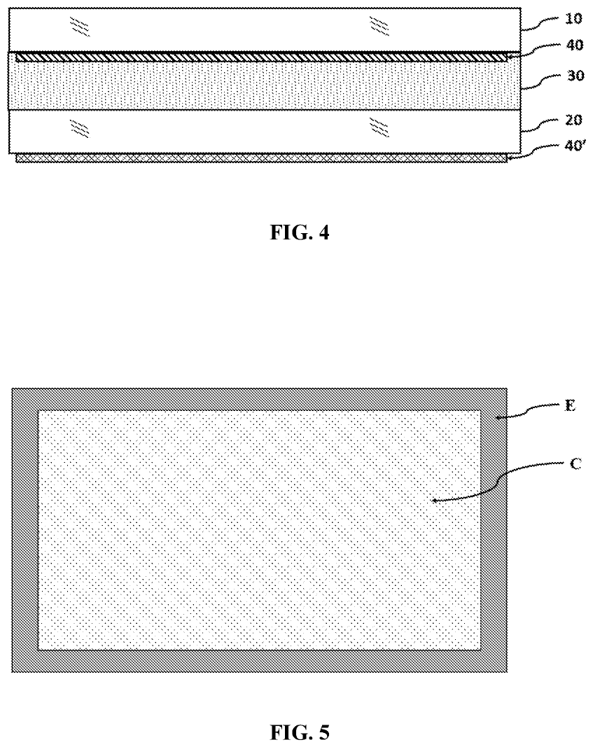

In addition, referring to FIG. 3 and FIG. 4, the present disclosure further provides another embodiment of the method for manufacturing a solar-control laminated glass, wherein FIG. 3 is a flow chart of the method for manufacturing a solar-control laminated glass, and FIG. 4 is a schematic structural view of the solar-control laminated glass manufactured according to the method for manufacturing a laminated glass shown in FIG. 3.

The similarity between this embodiment and the previous embodiment will not be repeated here. The difference between this embodiment and the previous embodiment lies in a step S220: forming solar-control coatings with different emissivities on the surface of the outer glass plate 10 and the surface of the inner glass plate, respectively. In a specific embodiment, an infrared reflective coating is provided on the surface (for example, the second surface) of the outer glass plate 10 facing the interlayer, and a low-emissivity coating is provided on the surface (for example, the fourth surface) of the inner glass plate 20 facing the internal environment (for example, indoors or the interior the vehicle).

By providing solar-control coatings with different functions on the surface of the outer glass plate and the surface of the inner glass plate at the same time, the obtained laminated glass is capable of not only reducing the energy of infrared ray passing through the glass, but also reducing the secondary radiation from the glass to the interior the vehicle.

According to the method of the present disclosure, those skilled in the art may arrange corresponding hot-bending parameters according to the property of the solar-control coatings contained in the two glass plates for forming the laminated glass, so as to ensure that the two hot-bent glass plates have a same curvature, thereby satisfying the curvature matching of the two glass plates. In this way, the diversity of design of glass may be satisfied, and the additional value of glass may be improved.

FIG. 4 shows the solar-control laminated glass manufactured according to the flow chart shown in FIG. 3, and comprising the outer glass plate 10, the inner glass plate 20, and the interlayer 30 sandwiched between the two glass plates, wherein the solar-control coating 40 is provided on the surface of the outer glass plate 10 facing the interlayer 30, and the solar-control coating 40′ is provided on the surface of the inner glass plate 20 facing the internal environment. In a specific embodiment, the solar-control coating 40 is an infrared reflective coating, and the solar-control coating 40′ is a low-emissivity coating. As mentioned above, the infrared reflective coating is capable of reflecting solar energy of the infrared band, and the low-emissivity coating is capable of reducing the secondary radiation to the internal environment after the glass absorbs heat. By providing the infrared reflective coating and the low-emissivity coating on the glasses at the same time, it is capable of not only reducing the proportion of the solar energy of the infrared band reaching the internal environment through the glass, but also reducing the heat of the secondary radiation from the glass to the internal environment.

In addition, in the field of vehicle glass, for an aesthetic requirement, as shown in FIG. 5, ink is generally printed on the edge area of the surface of the outer glass plate facing the interlayer and/or the surface of the inner glass plate facing the internal environment (such as indoors or the interior the vehicle), so as to cover glue used in the zone bonded to the vehicle body, or mechanical components and wirings for mounting the vehicle glass, etc. However, since the emissivity of the ink is generally higher than that of the solar-control coating, this will cause a different temperature gradient between the ink area (area E shown in FIG. 5) and the coating area (area C shown in FIG. 5) of the glass plate, such that the curvatures of the two areas after hot-bending will be different. However, if the heating temperature is increased in order to make the coating area reach the hot-bending temperature, the ink area will be overheated, thereby causing a problem of edge stress.

In view of this, according to some embodiments of the present disclosure, by adding solar-radiation reflective particles, such as near-infrared (NIR) reflective particles, in the ink, the heat-absorbing property of the ink area may be reduced, such that the heating of the entire glass plate is more uniform, and finally the hot-bending rates of the ink area and the coating area tend to be consistent.

According to other alternative embodiments of the present disclosure, by forming an organic layer containing an infrared absorber, such as carbon black or graphite, in the coating area, the heat-absorbing property of the coating area may be improved, and the organic layer containing carbon black or graphite may eventually be burned off at a high temperature. In a specific embodiment, an ink mainly made of graphite and water may be formed on the coating area by spraying. This may result in that the heating of the entire glass plate is more uniform, and finally the hot-bending rates of the ink area and the coating area tend to be consistent.

It should be understood that the above detailed embodiments of the present disclosure are only intended to exemplify or explain the principle of the present disclosure, rather than to limit the present disclosure. Therefore, any modifications, equivalent substitutions or improvements made within the spirit and principle of the present disclosure shall fall within the protection scope of the present disclosure. Besides, the appended claims of the present disclosure are intended to cover all changes and modifications within the scope and boundary of equivalent substitutions that fall within the scope and boundary of the claims.

1. A method for manufacturing a solar-control laminated glass comprising an outer glass plate, an inner glass plate and an interlayer sandwiched between the outer glass plate and the inner glass plate, the method comprising:
providing the outer glass plate and the inner glass plate;
forming a solar-control coating on a surface of at least one of the outer glass plate and the inner glass plate;
heating the outer glass plate and the inner glass plate;
hot-bending the heated outer glass plate and the heated inner glass plate respectively to obtain a glass-plate shape suitable for a subsequent pairing;
pairing the hot-bent outer glass plate and the hot-bent inner glass plate, and inserting the interlayer between the outer glass plate and the inner glass plate to form an assembly; and
heating and pressurizing the assembly to laminate the outer glass plate, the interlayer, and the inner glass plate together to form a laminated glass.

2. The method for manufacturing a solar-control laminated glass according to claim 1, wherein forming solar-control coatings with different emissivities on a surface of the outer glass plate and a surface of the inner glass plate, respectively.

3. The method for manufacturing a solar-control laminated glass according to claim 1, wherein forming the solar-control coating comprises: forming a laminated structure of at least one metal layer and at least one dielectric layer.

4. The method for manufacturing a solar-control laminated glass according to claim 1, wherein forming the solar-control coating comprises forming an infrared reflective coating or a low-emissivity coating.

5. The method for manufacturing a solar-control laminated glass according to claim 4, wherein the low-emissivity coating is formed by a magnetron sputtering method.

6. The method for manufacturing a solar-control laminated glass according to claim 1, wherein the outer glass plate and the inner glass plate are respectively hot-bent under different hot-bending parameters.

7. The method for manufacturing a solar-control laminated glass according to claim 1, wherein the outer glass plate and the inner glass plate are respectively hot-bent against a bending mold, and wherein a high-temperature resistant polymer mixture is provided on a surface of the bending mold in contact with the glass plates.

8. The method for manufacturing a solar-control laminated glass according to claim 7, wherein the high-temperature resistant polymer mixture is a mixture of a high-temperature resistant polymer and a metal yarn, and wherein the high-temperature resistant polymer is selected from poly-p-phenylene benzobisoxazole fiber or poly-p-phenylene terephthalamide fiber.

9. The method for manufacturing a solar-control laminated glass according to claim 1, wherein, before heating the outer glass plate and the inner glass plate, the method further comprises:
forming an ink layer containing solar-radiation reflective particles on an edge area of at least one surface of the outer glass plate and/or the inner glass plate.

10. The method for manufacturing a solar-control laminated glass according to claim 9, wherein the solar-radiation reflective particles are near-infrared reflective particles.

11. The method for manufacturing a solar-control laminated glass according to claim 1, wherein, before heating the outer glass plate and the inner glass plate, the method further comprises:
forming a coating comprising carbon black, graphite, or a mixture of carbon black and graphite on the solar-control coating.

12. A solar-control laminated glass manufactured according to the method for manufacturing a solar-control laminated glass according to claim 1.

13. The solar-control laminated glass according to claim 12, wherein the solar-control laminated glass comprises the outer glass plate, the inner glass plate, and the interlayer sandwiched between the outer glass plate and the inner glass plate, and wherein a surface of at least one of the outer glass plate and the inner glass plate is provided with a solar-control coating.

14. The solar-control laminated glass according to claim 13, wherein both of a surface of the outer glass plate and a surface of the inner glass plate are provided with a solar-control coating, and wherein the solar-control coating on the surface of the outer glass plate has a different emissivity from that of the solar-control coating on the surface of the inner glass plate.

15. The solar-control laminated glass according to claim 13, wherein the solar-control coating is an infrared reflective coating or a low-emissivity coating.

16. The solar-control laminated glass according to claim 15, wherein a surface of the outer glass plate or the inner glass plate facing the interlayer is provided with the infrared reflective coating.

17. The solar-control laminated glass according to claim 15, wherein a surface of the inner glass plate away from the interlayer is provided with the low-emissivity coating.

18. The solar-control laminated glass according to claim 15, wherein a surface of the outer glass plate facing the interlayer is provided with the infrared reflective coating, and a surface of the inner glass plate away from the interlayer is provided with the low-emissivity coating.
